(19) United States
(12) Patent Application Publication
(10) Pub. No.: US 2009/0029034 A1
(43) Pub. Date: Jan. 29, 2009

(54) Protective anode coatings

(76) Inventors: Mahnaz Jahedi, Victoria (AU); Enzo Gulizia, Victoria (AU); Chull Hee Oh, Victoria (AU); Stefan Gulizia, Victoria (AU)

Correspondence Address: JACOBSON HOLMAN PLLC, 400 SEVENTH STREET N.W., SUITE 600, WASHINGTON, DC, 20004, US

(21) Appl. No.: 11/666,640

(22) PCT Filed: Oct. 27, 2005
(86) PCT No.: PCT/AU05/01665

§ 371 Date: Dec. 3, 2007

(30) Foreign Application Priority Data
Oct. 28, 2004 (AU) 2004906236

(51) Int. Cl. B05D 5/12; C23F 11/00

(52) U.S. Cl. 427/78; 427/77; 252/387

(57) ABSTRACT

A coating system, for use in reducing air burn oxidation of a carbon anode of an aluminium electrolytic smelter, includes a pre-coat and a top coat which together enable protection of the anode when applied thereover. The pre-coat contains finely divided carbonaceous material dispersed in a solution of a suitable binder. The top coat contains finely divided particulate material, comprising at least one of alumina and cryolite, dispersed in a solution of a suitable binder.

This invention relates to an improved coating system for protecting carbon anodes from air burn oxidation in aluminium electrolytic smelters.

### BACKGROUND

Anode carbon loss by atmospheric oxidation above the electrolyte bath increases the material costs in smelting and, with pre-baked anodes, it considerably shortens anode life. Many types of coatings have been proposed for protecting anodes against air burn oxidation, but with little commercial success. Also, some coatings which in fact were capable of reducing anode burn were found to be unacceptable because they resulted in the introduction of undesirable impurities to the molten electrolyte or to the molten aluminium bath.

It is common practice to cover the top of pre-baked anodes with a mixture of alumina and crushed bath. This reduces air burn oxidation to a certain extent at the top of the anodes. However, as the mixture is loosely shovelled onto the anode, it is air permeable. Thus, as the temperature of the anode increases, air burn oxidation still occurs at the top of the anode. The oxidation becomes significant at anode temperatures in the region of 400° C., and increases in severity with increasing anode temperature.

The mixture shovelled onto the top of a pre-baked anode does not protect the side faces, while this expedient is not relevant to Söderberg anodes. In the absence of fully satisfactory coatings for protecting the side faces, some smelters spray molten aluminium onto the anode to minimise air burn oxidation. However, this is a dangerous and unpleasant practice and necessitates recycling of a small proportion of the end product.

### INTRODUCTION TO AND SUMMARY OF THE INVENTION

The present invention seeks to provide an anode coating system which is effective in reducing air burn oxidation of anodes of aluminium smelters.

The coating system of the present invention has a pre-coat (also able to be termed an undercoat) and a top coat which together enable protection of anodes against air burn oxidation.

According to the invention, the coating system, for use in reducing air burn oxidation of a carbon anode of an aluminium electrolytic smelter, wherein the coating system includes a pre-coat and a top coat which together enable protection of the anode when applied thereover, the pre-coat contains finely divided carbonaceous material dispersed in a solution of a suitable binder and the top coat contains finely divided particulate material dispersed in a solution of a suitable binder, and wherein the particulate material of the top coat comprises at least one of alumina and cryolite.

The invention also provides a method for reducing air burn oxidation of a carbon anode of an aluminium electrolytic smelter wherein the anode is provided with a coating built up by application, in turn, of pre-coat and top coat of the coating system of the invention.

The carbonaceous particulate material of the pre-coat preferably is high temperature oxidation resistant carbon or graphite.

The binder for the pre-coat most preferably is an aqueous solution of a silicate, such as sodium or potassium silicate.

The particulate material of the top coat may at least predominantly comprise alumina. In one preferred form, the particulate material comprises alumina alone. However, particulate cryolite can be used as an alternative to, or in addition to, alumina. Where cryolite is used in combination with alumina, the cryolite preferably is not present at greater than 40 wt % of the total particulate material of the top coat. Most preferably, the cryolite is present at a level of not more than 30 wt %, such that there is a clear predominance of alumina in the particulate material of the top coat.

The binder for the top coat most preferably is an aqueous solution of a silicate, such as sodium or potassium silicate.

Each of the pre-coat and top coat preferably has a weight ratio of particulate material to binder solids of from about 40% to about 60%. The ratio more preferably is from about 45% to about 53%, and satisfactory performance has been achieved at a ratio of about 50%.

The particulate material of the pre-coat may be, and preferably is, of lower average particle size than the particulate material of the top coat. The pre-coat serves to prepare the anode surface for application of the top coat such that the overall coating system is substantially non-porous and the top coat is strongly adhered to the anode.

The average particle size of the pre-coat may be about 15 micron, with some particles being of sub-micron sizes. The particle size distribution preferably is unimodal, with the particle size distribution at the relatively low average particle size facilitating relatively close packing of the particles in applied pre-coating.

The particulate material of the top coat most preferably is not unimodal. It is found to be beneficial to have a bimodal or trimodal particulate material in the top coat. This can assist in achieving a close-packed particle arrangement at the larger average particle size and, hence, a uniform coating substantially free of pores. Also, a bimodal or trimodal particulate material is found to minimise bubbling and cracking of the top coat in the course of its drying following application.

A suitable bimodal particulate material for the top coat is one having a coarse fraction with an average particle size of about 80 micron and a fine fraction with an average particle size of about 1 micron. A ratio of fine to coarse fractions of from about 35/65 to 45/55, and preferably about 40/60 is desirable. The material preferably is free of any particles larger than 1 mm.

The pre-coat and the top coat may be applied, in turn, by any suitable means. Thus, for example, application may be by dipping in the case of a pre-baked anode or, for both pre-baked and Söderberg anodes, application can be by spraying, wet gunning, brushing, painting and stuccoing.

The pre-coat most preferably is applied as a relatively thin coating, such that the total thickness of the applied coating system is predominantly due to the thickness of the top coat. This is facilitated by the relatively small particle size of the particulate material of the pre-coat. The ratio of solids to liquid needs to be such as to facilitate application of a thin pre-coat layer, while care also is necessary in the selection of the application technique in order to achieve the required relatively thin coating.

After application of the pre-coat, it is dried at a suitable temperature and for a suitable interval for removing the moisture content of the applied coating. The time and temperature for drying varies with the water content of the binder system. For the pre-coating silicate-based binder, drying at 80 to 150° C. for up to about 3 hours generally is sufficient.

After drying of the pre-coat, the top coat is applied, most preferably to a thickness of not more than about 1 mm. The top coat then is dried at a suitable temperature and for a suitable period. For the top coat silicate-based binder, drying can be at a temperature of from 80 to 200° C.,for a period of 2 to 8 hours. In some cases, a two-step drying operation, the first at a lower temperature and the second at a higher temperature, is likely to assist in preventing development of hair-line cracks and bubbles.

The pre-coat and the top coat are applied over all sides of the anode. In the case of a pre-baked anode, they also are applied over the top of the anode. The combined effect of the coating system is good oxidation protection for the anode, and a substantial reduction in air burn oxidation. As a result, the level of unscheduled changes arising from air burn oxidation is reduced.

The present invention facilitates use of anodes utilising cokes with higher vanadium and nickel content. Anodes made from coke containing vanadium and nickel is prone to more air burn oxidation. Also, the ability to cover all exposed surfaces of an anode eliminates the bath circuit, avoids additional crane movements necessary to bring alumina and crushed bath to the top of an uncoated anode. Also, the ability to cover all surfaces eliminates coarse and fine cleaning of anode butts taken out of the cell. Additionally, the coating system prevents the contamination of the anode butt from fluoride and soda hence, reduces damage to baked carbon furnaces. Of course, in assisting in retaining the effective surface area of an anode, by reducing air burn oxidation, the invention enables the anode to main its supply of electric current through the anode and facilitates better control of heat balance. The system of the invention also enables the practice of spraying molten aluminium to be discontinued.

Finally, it is to be understood that various other modifications and/or alterations may be made without departing from the spirit of the present invention as outlined herein.

1. A coating system, for use in reducing air burn oxidation of a carbon anode of an aluminium electrolytic smelter, wherein the coating system includes a pre-coat and a top coat which together enable protection of the anode when applied thereover, the pre-coat contains finely divided carbonaceous material dispersed in a solution of a suitable binder and the top coat contains finely divided particulate material dispersed in a solution of a suitable binder, and wherein the particulate material of the top coat comprises at least one of alumina and cryolite.

2. The coating system of claim 1, wherein the particulate material of the pre-coat is high temperature oxidation resistant carbon or graphite.

3. The coating system of claim 1, wherein the particulate material of the pre-coat is dispersed in an aqueous solution of a silicate, such as a silicate selected from sodium silicate and potassium silicate.

4. The coating system of claim 1, wherein the particulate material of the top coat substantially comprises alumina or cryolite.

5. The coating system of claim 1, wherein the particulate material of the top coat predominantly comprises alumina with the balance being cryolite.

6. The coating system of claim 1, wherein the particulate material of the top coat is dispersed in an aqueous solution of a silicate, such as a silicate selected from sodium silicate and potassium silicate.

7. The coating system of claim 1, wherein each of the pre-coat and the top coat has a weight ratio of particulate material to binder solids of from about 40% to about 60%, such as from about 45% to about 53%.

8. The coating system of claim 1, wherein the particulate material of the pre-coat is of lower average particle size then the particulate material of the top coat.

9. The coating system of claim 1 wherein the particulate material of the pre-coat has an average particle size of about 15 μm, with particles ranging down to sub-micron sizes.

10. The coating system of claim 9, wherein the particulate material of the pre-coat has a unimodal particle size distribution.

11. The coating system of claim 1, wherein the particulate material of the top coat is bimodal or trimodal.

12. The coating system of claim 1, wherein the particulate material is bimodal and has a coarse fraction with an average particle size of about 80 μm and a fine fraction with an average particle size of about 1 μm.

13. The coating system of claim 12, wherein the ratio of fine to coarse fractions is from about 35/65 to 45/55, such as about 40/60 and such as with the fractions free of any particles larger than about 1 mm.

14. The method for reducing air burn oxidation of a carbon anode of an aluminium electrolytic smelter wherein the anode is provided with a coating built up by application, in turn, of pre-coat and top coat of the coating system of claim 1.

15. The method of claim 14, wherein the anode is a pre-baked anode and each of the pre-coat and top coat is applied by the same respective means of dipping, spraying, wet gunning, brushing, painting and stuccoing.

16. The method of claim 14, wherein the anode is a pre-baked anode and each of the pre-coat and top coat is applied by the same respective means of spraying, wet gunning, brushing, painting and stuccoing.

17. The method of claim 14, wherein the pre-coat is applied as a relatively thin coating, with the total thickness of the applied coating system due predominantly to the thickness of the top coat.

18. The method of claim 14, wherein the pre-coat is dried to remove the moisture content thereof, such as at 80° to 150° C. for up to about 3 hours, before the top coat is applied.

19. The method of claim 14, wherein the top coat is dried, such as at 80° to 200° C. for a period of 2 to 8 hours.

20. The method of claim 18, wherein the top coat is dried in a two-step drying operation, with the first step at a lower temperature than the second step.
